(19) United States
(12) Patent Application Publication
(10) Pub. No.: US 2026/0083069 A1
(43) Pub. Date: Mar. 26, 2026

(54) AIR DOME DEVICE CAPABLE OF MAINTAINING POSITIVE PRESSURE AND CONTROLLING TEMPERATURE FOR CULTIVATING CROPS

(71) Applicant: AG-UNI Co.,Ltd, Gyeongsan-si (KR)

(72) Inventor: Mi Jin GWON, Seoul (KR)

(21) Appl. No.: 18/951,843

(22) Filed: Nov. 19, 2024

(30) Foreign Application Priority Data
Sep. 24, 2024 (KR) 10-2024-0129375

(51) Int. Cl. A01G 9/24; A01G 9/14

(52) U.S. Cl. CPC A01G 9/246; A01G 9/1438

(57) ABSTRACT

An air dome device may comprise: a membrane unit formed of a membrane and extended in one direction to form an inner space in which a set pressure is maintained; an entrance unit disposed in front of the membrane unit to allow outside air to flow in and be filtered; an air conditioning unit disposed in the rear of the membrane unit to form an air-conditioned space and to control the temperature and humidity of the outside air flowed in from the entrance unit; a branch pipe in the form of a pipe connecting the entrance unit and the air conditioning unit, which is inserted into the ground to provide a path through which the outside air flowed in from the entrance unit exchanges heat with ground heat; a blower unit formed with a blower space to blow air in the air-conditioned space or the air in the inner space.

### CROSS-REFERENCE TO RELATED APPLICATIONS

This application claims the priority of Korean Patent Application No. 10-2024-0129375 filed on September 24, 2024, in the Korean Intellectual Property Office, the disclosure of which is incorporated herein by reference.

### TECHNICAL FIELD

The present invention relates to an air dome device that enables continuous crop cultivation by increasing heat exchange efficiency within the interior while maintaining ventilation and temperature of the inner space, and also provides a space in which the user can operate.

### BACKGROUND ART

Membrane structures are a technology that uses vinyl or film as a membrane material to design buildings or building spaces. They are not only cost-effective, but also easy to construct, environmentally friendly, and lightweight, so they have been used for a long time. These membrane structures are generally used in various structures, such as skeletal membrane structures that tension or install membrane materials on steel or solid support structures, or hanging banner structures and the like that are installed by pulling membrane materials with climbing ropes to introduce tension.

However, in the case of the above membrane structures, since separate steel or cables are required, not only are there many materials that need to be prepared depending on the installation environment, but there are also complicated problems in terms of design and construction, and in particular, there are many restrictions on installation space. In addition, in the case of these membrane structures, since the tension of the membrane must be maintained by the steel, it is difficult to install them as large structures larger than a certain size, and since it is difficult to shield the inner space, the temperature or positive pressure in the inner space is not maintained, so in general, conditions for growing crops are not met.

On the other hand, the structures mainly used to cultivate crops by shielding the indoor space include containers or glass structures. In the case of containers, since they are manufactured in a module form and then moved and installed, it is impossible to manufacture them larger than the set size, so a large number of containers are required to cultivate crops in large quantities, which causes problems with cost and constructability. On the other hand, in the case of glass structures, sunlight coming in from the outside directly enters, which may be good for photosynthesis for crops, but it consumes a lot of energy to maintain the internal temperature, and there is a problem that a lot of time and money is spent on maintenance when damaged by external impact.

Accordingly, it is urgent to develop a membrane structure capable of maintaining positive pressure in the inner space and controlling temperature by using only membrane materials without separate steel or cables.

### Prior Art Literature

### Patent Literature

Domestic patent application No. 10-2013-0094852 (Title of invention: Air dome with snow prevention structure)

### DETAILED DESCRIPTION OF THE INVENTION

### Technical Subject

In order to solve the above problems, the purpose is to provide an air dome device that forms an inner space using only a membrane material and is capable of maintaining positive pressure and controlling temperature in the formed inner space. The present invention is not limited to the technical subjects described above, and other technical subjects may be derived from the following description.

### Technical Solution

An air dome device according to an embodiment of the present invention may comprise: a membrane unit formed of a membrane and being extended in one direction to form an inner space in which a set pressure is maintained; an entrance unit being disposed in front of the membrane unit to allow outside air to flow in and be filtered; an air conditioning unit being disposed in the rear of the membrane unit to form an air-conditioned space and to control the temperature and humidity of the outside air flowed in from the entrance unit; a branch pipe in the form of a pipe connecting the entrance unit and the air conditioning unit, which is inserted into the ground to provide a path through which the outside air introduced from the entrance unit exchanges heat with ground heat; a blower unit being formed with a blower space to blow air in the air-conditioned space or the air in the inner space; a distribution unit being disposed on one side of the blower space to distribute air being blown from the blower member; and a distribution line supplying the air distributed from the distribution member to the inner space.

In addition, the membrane unit includes a first membrane material being disposed on the outside to form an outer skin; and a second membrane material being disposed between the first membrane material and the inner space to form an inner skin, and a flow path blocker can be formed between the first membrane material and the second membrane material.

In addition, the blower unit may include a first blower fan being disposed in the blower space to supply air through forward rotation and a second blower fan being disposed in the blower space to suck air through reverse rotation, and the distribution line may include a first distribution line connecting an inlet side of the distribution unit and the flow path blocker and a second distribution line connecting an outlet side of the distribution unit and the flow path blocker.

In addition, the first blower fan and the second blower fan operate simultaneously so that conditioned air is introduced from the inlet side of the flow path blocker and conditioned air is discharged from the outlet side of the flow path blocker to the conditioned space, so that the pressure of the flow path blocker can be maintained.

In addition, the blower unit includes a third blower fan for supplying air through forward rotation; and a fourth blower fan for supplying or sucking air through forward or reverse rotation, and the distribution line includes a third distribution line disposed at at least one of one end and the other end of the membrane structure unit so as to be extended from the distribution unit by a set length, and a fourth distribution line connected to the inner space from the distribution unit, and the third distribution line can be disposed below a first set height.

In addition, the third distribution line is provided with a plurality of air inlets disposed at set at a set interval in the extension direction, wherein the air inlets may be formed to be inclined at a set angle toward the upper center of the membrane structure unit.

In addition, the membrane structure unit further includes an exhaust unit disposed at the rear, wherein an exhaust unit is disposed at a position higher than a second set height for exhausting air in the inner space to the outside, and wherein the second set height is greater than the first set height.

In addition, it may further include a housing forming the air conditioning space and the blower space, and the distribution unit may be disposed in the housing and include a first distribution port and a second distribution port for supplying or recovering air blown from the blower unit to the flow path blocker, at least one third distribution port for supplying air blown from the blower unit to the inner space, and a fourth distribution port for supplying air blown from the blower unit to the inner space or supplying air in the inner space to the air conditioning space.

In addition, the branch pipe may be buried in the ground parallel to each other so that a plurality of underground pipes have a length corresponding to the extension length of the membrane unit, and the inlet of the branch pipe may be disposed in the entrance unit and the outlet of the branch pipe may be disposed in the air conditioning space of the air conditioning unit.

### Advantageous Effects

The air dome device according to the above embodiment of the present invention has the following effects.

First, the entrance unit is disposed in front of the membrane unit, and the air conditioning unit and blower unit are disposed in the rear of the membrane unit, and an underground pipe is disposed between them so that the incoming outside air can be primarily heat-exchanged in the ground through the underground pipe and then introduced into the air-conditioned space, thereby increasing the heat exchange efficiency of the air conditioning unit and reducing energy consumption.

In addition, since the blower unit is designed to include a first blower fan and a second blower fan for supplying and recovering air to the flow path blocker, and a third blower fan and a fourth blower fan for supplying and recovering air to the inner space, the temperature of the air flowing into the flow path blocker and the inner space can be efficiently controlled as needed.

In particular, since the control unit controls the air conditioning unit, blower unit, and exhaust unit differently for each of the four integrated control conditions, it has the effect of maintaining the inner space temperature of the air dome device uniformly not only in spring or fall, but also in summer when the outside temperature is extremely high or in winter when the outside temperature is extremely low.

In addition, during the design process, the location where air flows into the inner space from the blower space of the air dome device is set to be below the first set height, and the location where the air from the inner space is distributed to the outside is set to be above the second set height, so that there is an effect in that the conditioned air being supplied to the entire inner space can be spread throughout the entire inner space, and conversely, the air being discharged to the outside for ventilation is efficiently exhausted.

### BRIEF DESCRIPTION OF DRAWINGS

FIG. 1 is a side view of an air dome device according to an embodiment of the present invention.

FIG. 2 is a front view of an air dome device according to an embodiment of the present invention.

FIG. 3 is a top view illustrating the inside of an air dome device according to an embodiment of the present invention.

FIG. 4 is a rear view of an air dome device according to an embodiment of the present invention.

FIG. 5 is a drawing illustrating the entrance unit structure of an air dome device according to an embodiment of the present invention.

FIGS. 6 and 7 are drawings illustrating an air conditioning unit, a distribution unit, and a distribution line of an air dome device according to an embodiment of the present invention.

FIG. 8 is a drawing illustrating an air conditioning unit and a blower unit of an air dome device according to an embodiment of the present invention.

FIG. 9 is a drawing illustrating an exhaust unit of an air dome device according to an embodiment of the present invention.

FIG. 10 is a drawing illustrating a distribution line of an air dome device according to an embodiment of the present invention.

FIG. 11 is a configuration diagram of a control unit and a sensor unit of an air dome device according to an embodiment of the present invention.

FIG. 12 is a flow chart illustrating an operation step of a control unit of an air dome device according to an embodiment of the present invention.

### SPECIFIC DETAILS FOR IMPLEMENTING THE INVENTION

Hereinafter, with reference to the attached drawings, embodiments of the present invention will be described in detail so that a person having ordinary skill in the art to which the present invention belongs can easily implement the present invention.

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as "at least one (or more than one) of A and B and C", it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being 'connected', 'coupled' or 'interconnected' to another component, the component is not only directly connected, coupled or interconnected to the other component, but may also include cases of being 'connected', 'coupled', or 'interconnected' due that another component between that other components.

In addition, when described as being formed or disposed in "on (above)" or "below (under)" of each component, "on (above)" or "below (under)" means that it includes not only the case where the two components are directly in contact with, but also the case where one or more other components are formed or disposed between the two components. In addition, when expressed as "on (above)" or "below (under)", the meaning of not only an upward direction but also a downward direction with respect to one component may be included.

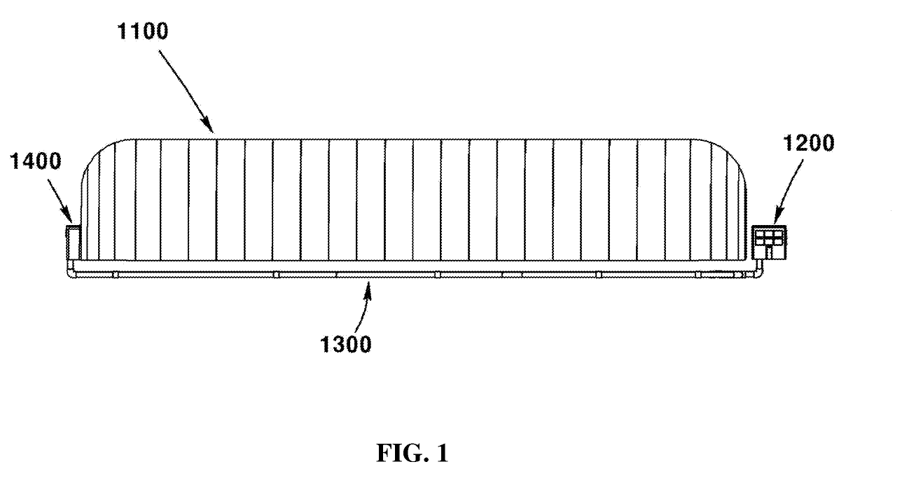

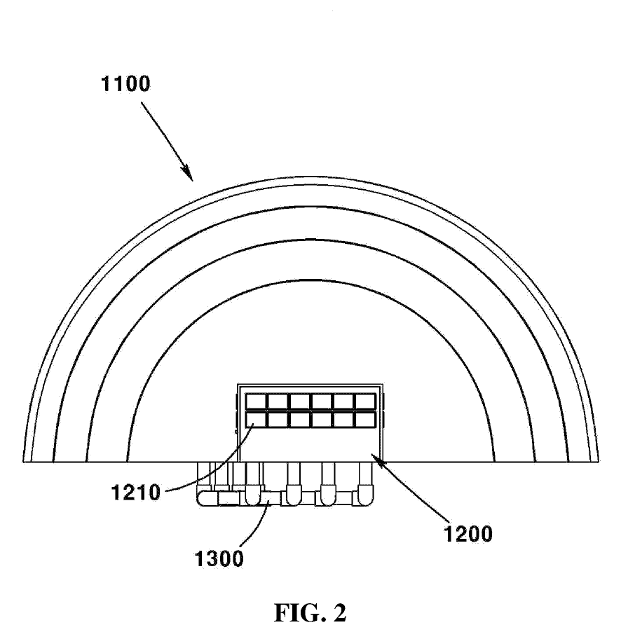

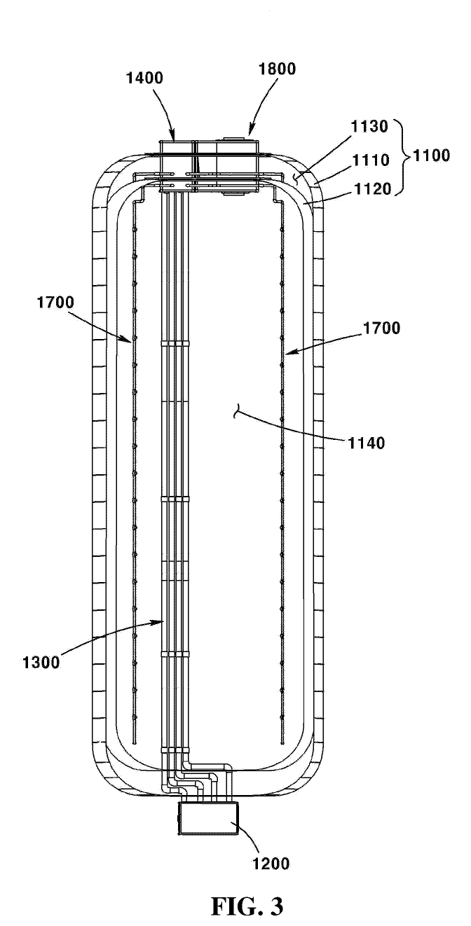

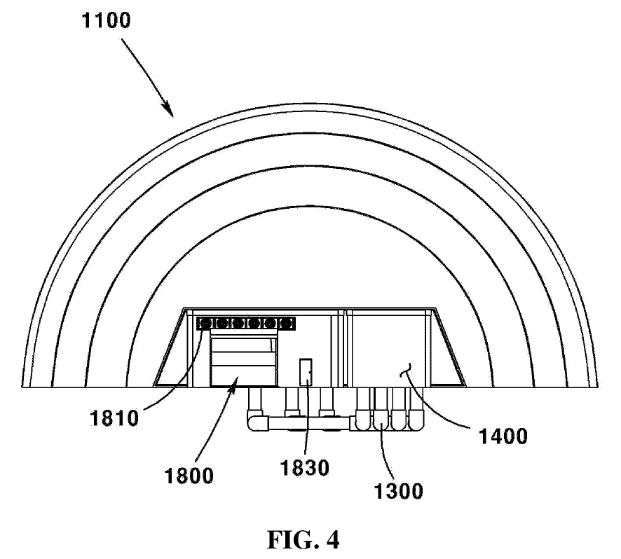

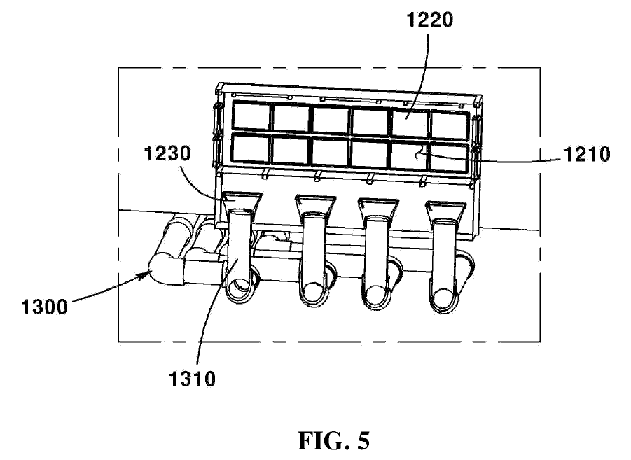

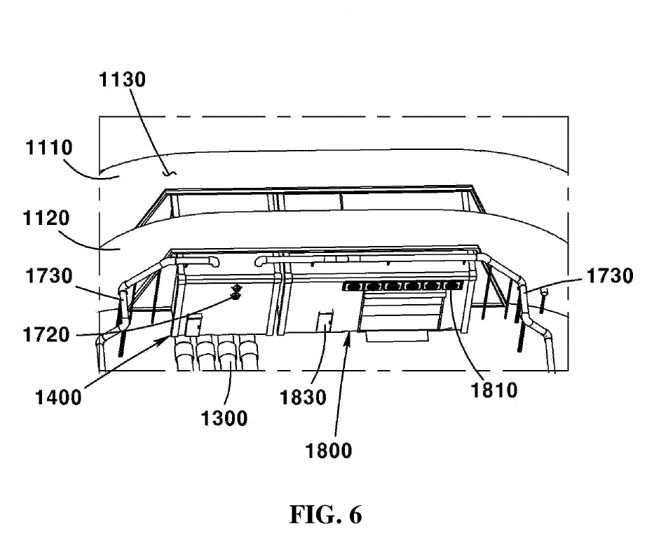

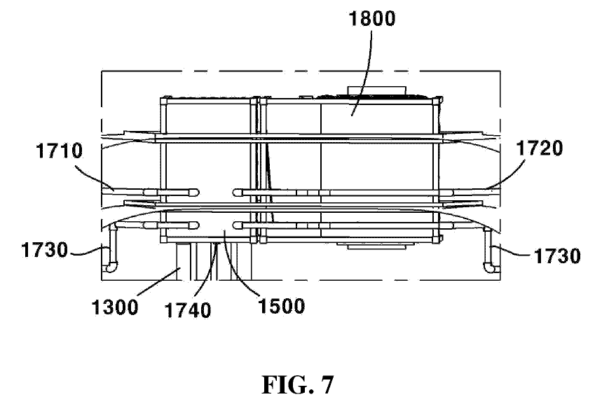

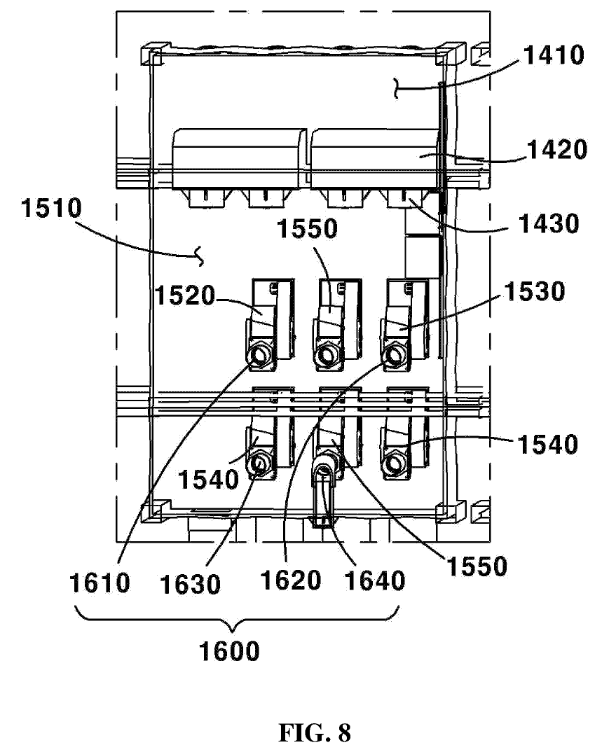

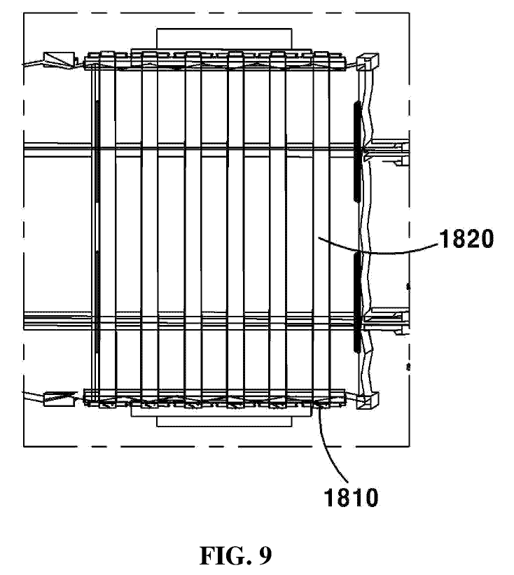

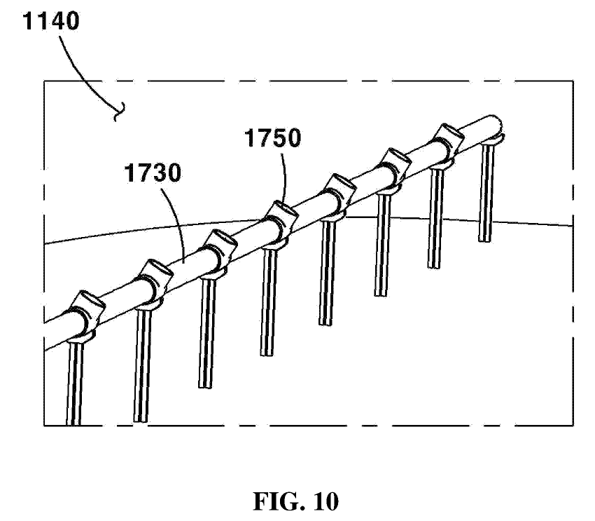

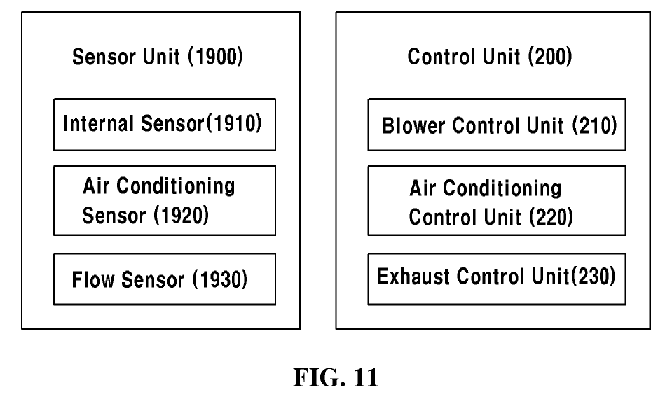

FIG. 1 is a side view of an air dome device according to an embodiment of the present invention; FIG. 2 is a front view of an air dome device according to an embodiment of the present invention; FIG. 3 is a top view illustrating the inside of an air dome device according to an embodiment of the present invention; FIG. 4 is a rear view of an air dome device according to an embodiment of the present invention; FIG. 5 is a drawing illustrating the entrance unit structure of an air dome device according to an embodiment of the present invention; FIGS. 6 and 7 are drawings illustrating an air conditioning unit, a distribution unit, and a distribution line of an air dome device according to an embodiment of the present invention; FIG. 8 is a drawing illustrating an air conditioning unit and a blower unit of an air dome device according to an embodiment of the present invention; FIG. 9 is a drawing illustrating an exhaust unit of an air dome device according to an embodiment of the present invention; FIG. 10 is a drawing illustrating a distribution line of an air dome device according to an embodiment of the present invention; and FIG. 11 is a configuration diagram of a control unit and a sensor unit of an air dome device according to an embodiment of the present invention.

Referring to FIGS. 1 to 11, an air dome system according to an embodiment of the present invention comprises: a membrane unit 1100 forming an exterior and including an inner space 1140; an entrance unit 1200 being disposed in front of the membrane unit 1100 to allow outside air to flow into the interior; an air conditioning unit for controlling the temperature and humidity of air flowing in from the entrance unit 1200; a branch pipe 1300 being disposed between the entrance unit 1200 and the air conditioning unit to primarily exchange heat with the ground heat from the outside air flowing in from the entrance unit 1200; a blower unit 1500 for blowing air whose temperature and humidity have been controlled from the air conditioning unit; a distribution unit 1600 for performing distribution from the blower unit 1500 to a distribution line; a distribution line for distributing conditioned air from the distribution unit 1600 to the inner space 1140; an exhaust unit 1800 for discharging air conditioned from the distribution unit 1600 to the inner space 1140 under set conditions of the inner space 1140; a sensor unit 1900 that measures the temperature and humidity of the space between the outer space, the inner space 1140 and the membrane; and a control unit 200 that controls the air conditioning unit, the blower unit 1500 and the exhaust unit 1800 based on the measurement results of the sensor unit 1900.

The membrane unit 1100 is a means for forming the outer appearance of the air dome device and may include a first membrane material 1110 disposed on the exterior and a second membrane material 1120 forming an inner space 1140. That is, the outer skin may be formed of the first membrane material 1110 and the interior may be formed of the second membrane material 1120. A flow path blocker 1130 may be formed between the first membrane material 1110 and the second membrane material 1120 to maintain the temperature of the inner space 1140 and prevent the temperature and humidity of the outer space from affecting the inner space 1140. The flow path blocker 1130 means a flow path that is maintained to have a set width between the first membrane material 1110 and the second membrane material 1120, and the outer space and the inner space 1140 may be completely separated by the flow path blocker 1130.

The membrane unit 1100 can be formed of a semitransparent film-shaped material, through which 80% of external sunlight can be transmitted into the inner space 1140, and the transmitted sunlight is changed into scattered light in the process of flowing into the inner space 1140, so that an equal amount of light is supplied to the inner space 1140 as a whole, thereby enabling to create an environment favorable for crop cultivation.

The membrane unit 1100 may be formed in an oval shape being extended in length as it travels from the front to the rear when viewed from the outside and the length of each side surface is shorter than the length extended from the front to the rear. However, this is for efficient space arrangement for crop cultivation, and it is not limited to this, but may be installed so as to enable formation of a circular or other various shapes of inner space 1140.

The entrance unit 1200 is disposed in front of the membrane unit 1100 and is a means for introducing outside air. In detail, the entrance unit 1200 has an inflow space 1210 formed therein for introducing outside air, and one or more filters 1220 are disposed in the inflow space 1210 to enable primarily filtering of the outside air. In this case, the filter 1220 may be a HEPA filter 1220.

In addition, the entrance unit 1200 may have one or more inlet pipes 1230 formed on the lower side. The inlet pipe 1230 is connected to the inlet side of the branch pipe 1300 to be described later, so that outside air introduced into the inflow space 1210 may be introduced into the underground pipe of the branch pipe 1300 through the inlet pipe 1230.

The branch pipe 1300 may include one or more underground pipes buried in the ground. In this case, the inlet side of the branch pipe 1300 may be connected to the inlet pipe 1230 of the entrance unit 1200, and the outlet side may be connected to the outlet pipe of the air conditioning unit. Outside air introduced through the entrance unit 1200 may be introduced into the branch pipe 1300 through the inlet pipe 1230, and in the process of flowing through the underground portion buried in the ground, heat exchange may be primarily performed by geothermal heat, and may be supplied to the air conditioning space 1410 of the air conditioning unit through the outlet pipe. In general, in the summer, the temperature of the outside air is higher than the ground temperature, which is the geothermal heat, and in the winter, the temperature of the outside air is lower than the ground temperature, which is the geothermal heat. Therefore, heat exchange can occur as the outside air moves through the branch pipe 1300, and in the summer, the outside air is supplied to the air conditioning unit in a lowered state, and in the winter, the outside air is supplied to the air conditioning unit in an elevated state, thereby reducing the power used in the air conditioning unit.

The air conditioning unit is a means for controlling the temperature and humidity of the outside air that is primarily heat-exchanged through the branch pipe 1300 by being disposed on the outlet side of the branch pipe 1300 at the rear of the membrane unit 1100. In detail, the air conditioning unit may include one or more outlet pipes connected to the outlet side of the branch pipe 1300, an air conditioning space 1410 for conditioning air supplied from the outlet pipe, and one or more heat exchangers 1420 for controlling the temperature and humidity. The air conditioning space 1410 may form a single space with the blower space 1510 of the blower unit 1500 to be described later, but is not limited thereto, and may be formed as a space separated by the heat exchanger 1420 if necessary. The outside air supplied to the air conditioning space 1410 through the branch pipe 1300 may have its temperature and humidity controlled through the air conditioning unit and supplied to the blower space 1510. In addition, air that has been heat-exchanged and conditioned by the heat exchanger 1420 can flow to the blower space 1510 through the air conditioning fan 1430.

The blower unit 1500 is a means for providing power for supplying air being conditioned through the air conditioning unit and the outside air through the entrance unit 1200 to the inner space 1140 and the flow path blocker 1130. In detail, the blower unit 1500 may include one or more blower fans disposed in the blower space 1510 to which the conditioned air is supplied from the air conditioning unit. The pressure may be changed by the rotational power of the blower fan to form an air flow, and as a result, the outside air may be introduced into the entrance unit 1200 and the air in the blower space 1510 may be introduced into the inner space 1140.

A blower fan may be disposed in the blower space 1510 and may be disposed in multiple numbers. In detail, the blower fan may include a first blower fan 1520, a second blower fan 1530, a third blower fan 1540, and a fourth blower fan 1540.

The first blower fan 1520 is disposed to be capable of forward rotation and is a means for generating an air supplying power to supply air in the blower space 1510 to the flow path blocker 1130, and the second blower fan 1530 is disposed to be capable of reverse rotation and is a means for generating an air suction power to recover the air supplied to the flow path blocker 1130. In other words, the first blower fan 1520 and the second blower fan 1530 are means for providing a power for supplying and recovering air flowing inside the flow path blocker 1130.

The third blower fan 1540 is disposed to be capable of forward rotation and is a means for generating an air supplying power to supply air in the blower space 1510 to the inner space 1140, and the second blower fan 1530 is disposed to be capable of forward or reverse rotation and is a means for generating an air supplying power or a recovery driving force to supply air in the blower space 1510 to the inner space 1140 or recover air in the inner space 1140 to the blower space 1510 as needed. As an example, a BLDC motor capable of bidirectional rotation may be used as the fourth blower fan 1540. That is, the third blower fan 1540 and the fourth blower fan provide power to supply conditioned air to the inner space 1140, or, if necessary, the fourth blower fan 1540 provides power to recover air from the inner space 1140 to the blower space 1510.

In addition, the power being generated by the third blower fan 1540 can always be designed to have greater power than the power generated by the fourth blower fan 1540. This is because the power of the third blower fan 1540 must be greater to generate power to draw outside air into the inner space 1140.

The number of the first to fourth blower fans 1540 may vary depending on the user's design. For example, when six blower fans are disposed, the first and second blower fans 1530 are disposed one each, the third blower fan 1540 is disposed three each, and the fourth blower fan 1540 is disposed one each, so that the number of the third blower fan 1540 may be greater than the number of other blower fans.

In addition, the rotation speed, that is, the rotation speed of the first to fourth blower fans 1540, can be adjusted as needed. For example, the rotation speed of the third blower fan 1540 can be adjusted as needed. The third blower fan 1540 can be controlled so that its rotation speed is adjusted according to the operation of the fourth blower fan 1540, and a detailed description of the rotation speed adjustment of the third blower fan 1540 will be described later.

The distribution unit 1600 is a means for distributing the fluid pressure being generated by the power of the blower unit 1500 to a distribution line. The distribution unit 1600 may include one or more distribution ports formed in an opening shape in a structure forming a blower space 1510, and the distribution ports may be respectively connected to blower fans of the blower unit 1500. In detail, the distribution ports may include a first distribution port 1610 being connected to a first blower fan 1520, a second distribution port 1620 being connected to a second blower fan 1530, a third distribution port 1630 being connected to a third blower fan 1540, and a fourth distribution port 1640 connected to a fourth blower fan 1540. The number of distribution ports may be disposed in a number corresponding to the number of blower fans.

Here, the air conditioning space 1410 and the blower space 1510 can be formed as a single space. The air conditioning space 1410 and the blower space 1510 can be formed by a single housing 1400, and in this case, both the air conditioning unit and the blower unit 1500 can disposed in a space inside the housing 1400. In addition, the distribution unit 1600 is disposed at a set position on the upper surface and the front surface of the housing 1400, so that air conditioning, ventilation, and distribution of outside air to be moved to a distribution line through a single housing 1400 can be performed. For example, this housing 1400 can be defined as a machine room.

The distribution line 1700 is a means being connected to the distribution unit 1600 to provide a path for supplying conditioned air to the inner space 1140 and the flow path blocker 1130 or recovering air from the inner space 1140 and the flow path blocker 1130. In detail, the distribution line 1700 may include a first distribution line 1710, a second distribution line 1720, a third distribution line 1730, and a fourth distribution line 1740.

The first distribution line 1710 is a flow path for supplying the conditioned air being supplied by the air supplying power of the first blower fan 1520 to the flow path blocker 1130 of the membrane unit 1100 by being connected to the first distribution port 1610. In detail, the first distribution line 1710 has an inlet side connected to the first distribution port 1610 and an outlet side disposed on one side of the flow path blocker 1130 between the first membrane 1110 and the second membrane 1120, thereby continuously supplying the conditioned air being supplied from the first blower fan 1520 to the flow path blocker 1130.

The second distribution line 1720 is a flow path being connected to the second distribution port 1620 to suck air from the flow path blocker 1130 into the blower space 1510 by the air suction power of the second blower fan 1530. In detail, the second distribution line 1720 has an inlet side connected to the second distribution port 1620 and an outlet side disposed on the other side of the flow path blocker 1130 between the first membrane 1110 and the second membrane 1120, so that air inside the flow path blocker 1130 can be continuously recovered into the blower space 1510 by the air suction power being generated from the second blower fan 1530.

As the conditioned air of the blower space 1510 is continuously supplied to one side of the flow path blocker 1130 by the first distribution line 1710 and the second distribution line 1720, and the air inside the flow path blocker 1130 is continuously sucked into the blower space 1510 on the other side of the flow path blocker 1130, the internal air of the flow path blocker 1130 can continuously maintain a comfortable temperature and humidity, and the pressure inside the flow path blocker 1130 can be constantly maintained above the set pressure. Accordingly, the air of the flow path blocker 1130 acts as a buffer between the outside air and the inner space 1140, thereby increasing the temperature maintenance efficiency of the inner space 1140. Here, the set pressure inside the flow path blocker 1130 is defined as the set flow pressure.

The third distribution line 1730 is a flow path connected to the third distribution port 1630 to supply conditioned air inside the blower space 1510 to the inner space 1140 by the air supplying power of the third blower fan 1540. In detail, the third distribution line 1730 may be disposed such that the inlet side is connected to the third distribution port 1630 and extended from one end of the membrane unit 1100 and/or the other end by a length corresponding to the length of one end of the membrane unit 1100 and/or the other end.

In this case, a plurality of air inlets 1731 may be disposed along the extension length of the third distribution line 1730 at set intervals. In this case, the air inlets 1731 may be formed to be inclined from the ground surface at a set angle toward the upper center of the inner space 1140 so as to supply conditioned air toward the upper center of the membrane unit 1100. That is, the third distribution line 1730 may be disposed so as to be extended along the length of one side or the other side of the membrane unit 1100 and have air inlets 1731 formed at set intervals along the extended line so as to supply conditioned air toward the upper center of the membrane unit 1100. This allows circulation and temperature change of the internal air to occur more efficiently.

In addition, the third distribution line 1730 may be disposed below the first set height. For example, the third distribution line 1730 may be disposed at a height lower than the exhaust fan 1810 of the exhaust unit 1800 to be described later. Since the third distribution line 1730 is disposed below the first set height, the conditioned air introduced into the inner space 1140 through the third distribution line 1730 circulates in the inner space 1140 and may be exhausted to the outside from the exhaust unit 1800 after the circulation as needed. Therefore, there is an effect of preventing the conditioned air introduced into the inner space 1140 through the third distribution line 1730 from being exhausted to the outside before the circulation.

The fourth distribution line 1740 is a flow path being connected to the fourth distribution port 1640 to supply conditioned air inside the blower space 1510 to the inner space 1140 by the air supplying power of the fourth blower fan 1540 or to suck air inside the inner space 1140 into the blower space 1510 by the air suction power. In detail, the fourth distribution line 1740 may have an inlet side connected to the fourth distribution port 1640 and an outlet side disposed in the inner space 1140, and may be a flow path through which air in the blower space 1510 is introduced into the inner space 1140 or air in the inner space 1140 is introduced into the blower space 1510 by the operation of the fourth blower fan 1540 under the control of the control unit 200. That is, the air flowing through the fourth distribution line 1740 can selectively flow in one direction or the other direction of the line.

The air conditioned by the air conditioning unit in the blower space 1510 can be evenly supplied toward the upper center of the inner space 1140 by the third distribution line 1730 and the fourth distribution line 1740, thereby controlling the temperature and humidity of the inner space 1140. In addition, the pressure of the inner space 1140 is maintained at a set pressure or higher by the third distribution line 1730 and the fourth distribution line 1740, thereby satisfying the positive pressure condition of the inner space 1140, thereby maintaining the inner space 1140. Here, the set pressure for maintaining the inner space 1140 is defined as the set internal pressure. In addition, if necessary, the air in the inner space 1140 can be recovered to the blower space 1510 by the fourth distribution line 1740 and supplied back to the inner space 1140 in a mixed state with the air conditioned in the blower space 1510, thereby simultaneously performing the ventilation effect and the temperature and humidity control effect of the inner space 1140.

The exhaust unit 1800 is disposed on one side of the air conditioning unit at the rear of the membrane unit 1100 and is a means for exhausting air in the inner space 1140 to the outside under exhaust conditions, and may form an exhaust fan 1810 being disposed in the inner space 1410 to provide exhaust power, an exhaust path 1820 being extended to the outside from the exhaust fan 1810, and an entrance unit 1830 for entry and exit of a vehicle or a user. Here, the exhaust fan 1810 may be disposed to be aligned in a horizontal direction on a plurality of ground surfaces, and the arrangement height of the exhaust fan 1810 may be disposed at a position higher than a second set height. Here, the second set height may be a height that exceeds the first set height. Through this, the air exhausted to the outside from the exhaust fan 1810 may be the upper air of the inner space 1140, so there is an effect of enabling efficient air circulation in the inner space 1140. The exhaust conditions for the operation of the exhaust fan 1810 of the exhaust unit 1800 will be described later.

The sensor unit 1900 may include an external sensor being disposed outside the membrane unit 1100 to sense the temperature and humidity of the outside air, an internal sensor 1910 being disposed in the inner space 1140 to sense the temperature, humidity, and pressure of the air in the inner space 1140, an air conditioning sensor 1920 being disposed in the air conditioning space 1410 to sense the temperature and humidity of the conditioned air, and a flow sensor 1930 being disposed in the flow path blocker 1130 between the first membrane material 1110 and the second membrane material 1120 of the membrane unit 1100 to sense the temperature, humidity, and pressure of the air flowing through the flow path blocker 1130. Here, each sensor may be disposed in one or more, or in multiple numbers, if necessary, and when multiple numbers are disposed, the average values of the temperature, humidity, and pressure measured in each sensor may be calculated to calculate the final temperature, humidity, and pressure.

The control unit 200 is a means for controlling air conditioning, blowing, and exhaust of the air dome device. In detail, the control unit 200 may include an air conditioning control unit 220 for controlling the operation of the air conditioning unit, a blower control unit 210 for controlling the operation of the blower unit 1500, and an exhaust control unit 230 for controlling the operation of the exhaust unit 1800. The operation of the control unit 200 will be described in detail below.

First, the air conditioning control unit 220 of the control unit 200 can determine the first air conditioning temperature and the first air conditioning humidity value of the conditioned air to be introduced into the inner space 1140 based on the temperature and humidity measurement values of the external sensor and the internal sensor 1910 of the sensor unit 1900. That is, when the set internal temperature and the set internal humidity value of the internal air of the inner space 1140 are determined, the air conditioning control unit 220 can determine the first air conditioning temperature and the second air conditioning humidity value of the conditioned air to be supplied based on the temperature and humidity value of the outside air, and can operate the air conditioning unit until the air inside the air conditioning space 1410 has the determined temperature and humidity value.

When the air in the air conditioning space 1410 reaches the set first air conditioning temperature and first air conditioning humidity, the air conditioning control unit 220 can stop the operation of the air conditioning unit or determine a second air conditioning temperature and a second air conditioning humidity value of the conditioned air to maintain the set internal temperature and set internal humidity values of the air in the inner space 1140 and continuously operate the conditioned air to maintain them.

In addition, the air conditioning control unit 220 of the control unit 200 can control the air conditioning unit to operate when the temperature value of the flow path blocker 1130 measured by the flow sensor 1930 of the sensor unit 1900 deviates from the average value of the outside temperature and the temperature of the inner space 1140 by a set range or more. Through this, the temperature of the flow path blocker 1130 between the first membrane material 1110 of the membrane unit 1100 and the second membrane material 1120 of the membrane unit 1100 is controlled to maintain a value between the outside air and the inner space 1140 temperature, thereby preventing the inside temperature from being changed by the outside.

In addition, the blower control unit 210 of the control unit 200 can control the operation of the blower unit 1500 so that the pressure value of the inner space 1140 measured by the internal sensor 1910 of the sensor unit 1900 maintains the set internal pressure value. In detail, when the pressure value of the inner space 1140 is lower than the first set internal pressure value, the blower control unit 210 can increase the air supply amount supplied to the inner space 1140 per unit time by controlling the rotation speed of the third blower fan 1540 to exceed the first set rotation speed, thereby increasing the pressure value of the inner space 1140. On the other hand, when the pressure value of the inner space 1140 exceeds the second set internal pressure value, the pressure value of the inner space 1140 can be reduced by controlling the rotation speed of the third blower fan 1540 to be lower than the second set rotation speed and by reducing the air supply amount supplied to the inner space 1140 per unit time. If the pressure value of the inner space 1140 has a value between the first set internal pressure value and the second set internal pressure value, the pressure value of the inner space 1140 can be kept constant by controlling the rotation speed of the third blower fan 1540 to maintain the rotation speed between the first set rotation speed and the second set rotation speed.

In addition, the blower control unit 210 of the control unit 200 can control the operation of the blower unit 1500 so that the pressure value inside the flow path blocker 1130 measured by the flow sensor 1930 of the sensor unit 1900 maintains the set flow path pressure value. In detail, the blower control unit 210 can control the exhaust control unit 230 of the control unit 200 of the first blower fan 1520 and the second blower fan 1530 to operate the exhaust unit 1800 based on the temperature and humidity measurement values of the outside sensor and the internal sensor 1910. The exhaust control unit 230 operates only under exhaust conditions, and a detailed description thereof will be described later.

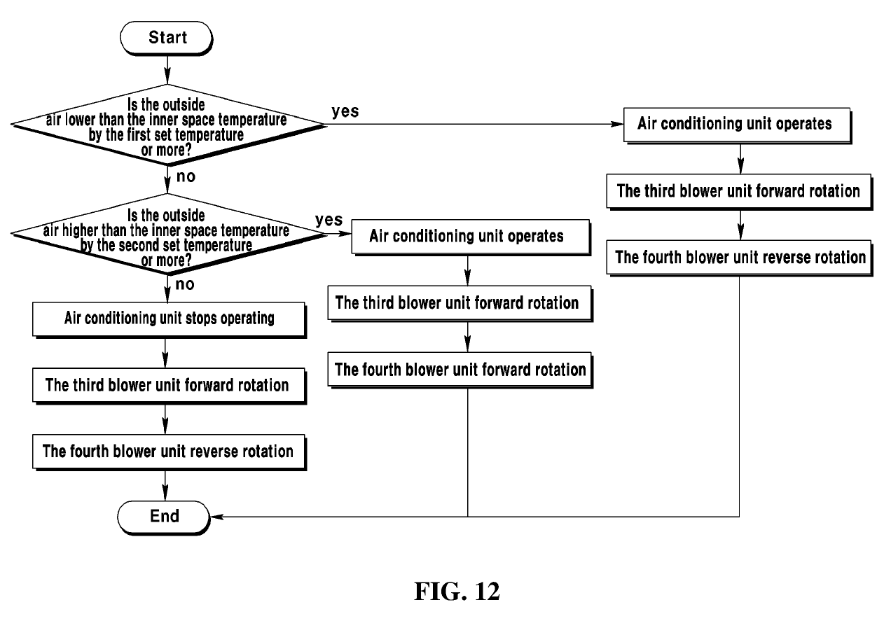

Below, the temperature integrated control operation of the control unit 200 according to the measurement value of the sensor unit 1900 is described. FIG. 12 is a flow chart illustrating the operation steps of the control unit of the air dome device according to an embodiment of the present invention. Referring to FIG. 12, the integrated control conditions of the air conditioning unit, blower unit 1500, and exhaust unit 1800 of the control unit 200 can be operated differently depending on the first to fourth integrated control conditions.

The first integrated control condition is when the outside temperature is lower than the temperature of the inner space 1140 by the first set temperature or more, the second integrated control condition is when the outside temperature is lower than the temperature of the inner space 1140 by the first set temperature or less, the third integrated control condition is when the outside temperature is higher than the temperature of the inner space 1140 by the second set temperature or more, and the fourth integrated control condition is when the outside temperature is higher than the temperature of the inner space 1140 by the second set temperature or less.

In the first integrated control condition, the control unit 200 can control so as to operate the air conditioning unit and blower unit 1500 but not to operate the exhaust unit 1800. In detail, in the first integrated control condition, the air conditioning control unit 220 of the control unit 200 controls the air conditioning unit to condition the outside air that is introduced from the entrance unit 1200, is primarily heat-exchanged through the branch pipe 1300, and is introduced into the air conditioning space 1410 to generate hot air having a temperature higher than the outside temperature and provide it to the blower space 1510. In addition, the blower control unit 210 of the control unit 200 can supply the conditioned hot air of the blower space 1510 to the inner space 1140 by rotating the third blower fan 1540 in the forward direction, and at the same time, the blower control unit 210 of the control unit 200 can return the internal air of the inner space 1140 to the blower space 1510 by rotating the fourth blower fan 1540 in the reverse direction. In this process, when the third blower fan 1540 and the fourth blower fan 1540 is disposed in the same number, the rotation speed of the third blower fan 1540 is increased, or when the number of third blower fans 1540 is greater than the number of fourth blower fans 1540, the rotation speed is maintained the same so that the amount of air flowing into the inner space 1140 is greater than the amount of air returned to the blower space 1510, thereby maintaining the pressure of the inner space 1140. Through this, the air of the inner space 1140 flowing into the blower space 1510 through the fourth blower fan 1540 under the first integrated control condition can be mixed with the hot air conditioned by the air conditioning unit and supplied back to the inner space 1140 by the third blower fan 1540.

Under the first integrated control condition, when the conditioned hot air from the air conditioning unit flows into the inner space (1140), the hot air can move to the upper side of the inner space (1140) due to the temperature difference, and as a result, the existing air in the inner space (1140) moves to the lower side, and the circulation of the inner space (1140) can occur automatically. In addition, during this process, since a part of the air in the inner space (1140) flows into the blower space (1510) through the fourth blower fan (1540) and is re-conditioned, so there is an effect that the heat exchange efficiency of the air conditioning unit increases, thereby reducing energy consumption.

In the second integrated control condition, the control unit 200 can control so as to operate the blower unit 1500 but not to operate the air conditioning unit and exhaust unit 1800. In detail, in the second integrated control condition, the air conditioning control unit 220 of the control unit 200 controls the air conditioning unit not to operate, and at the same time, the blower control unit 210 rotates the third blower fan 1540 in the forward direction to supply the outside air introduced into the blower space 1510 through the air conditioning space 1410 to the inner space 1140, and at the same time, the blower control unit 210 of the control unit 200 rotates the fourth blower fan 1540 in the reverse direction to recover the internal air of the inner space 1140 back to the blower space 1510. In this process, when the third blower fan 1540 and the fourth blower fan 1540 are disposed in the same number, the rotation speed of the third blower fan 1540 is increased, or the number of third blower fans 1540 is increased, or in the case where the number of fans 1540 is greater than the number of fans 1540, the rotation speed can be kept the same so that the amount of air flowing into the inner space 1140 is greater than the amount of air returning to the blower space 1510, thereby maintaining the pressure of the inner space 1140.

In the second integrated control condition, since the air in the inner space 1140 is maintained at a certain level, a problem may occur in which separate circulation does not occur, and to solve this problem, the third blower fan 1540 supplies air in the blower space 1510 to the inner space 1140, while the fourth blower fan 1540 recovers air in the inner space 1140 to the blower space 1510, and the outside air flowing into the blower space 1510 and the recovered air are mixed and re-supplied to the inner space 1140 through the third blower fan 1540, and therefore, the air in the inner space 1140 can be automatically circulated and ventilated.

In the third integrated control condition, the control unit 200 can control the air conditioning unit, blower unit 1500, and exhaust unit 1800 to operate. In detail, in the third integrated control condition, the air conditioning control unit 220 of the control unit 200 controls the air conditioning unit to conditioned the outside air that is initially heat-exchanged through the branch pipe 1300 and is introduced from the entrance unit 1200, thereby generating cold air having a temperature lower than the outside temperature and providing it to the blower space 1510. In addition, the blower control unit 210 of the control unit 200 can supply the conditioned cold air of the blower space 1510 to the inner space 1140 by rotating the third blower fan 1540 and the fourth blower fan 1540 forward. In this process, since the third pipe path of the inner space 1140 is arranged below the first set height, the cold air can be supplied preferentially to the lower space of the inner space 1140. When cold air is supplied to the inner space 1140, the air in the existing inner space 1140 moves to the upper part of the inner space 1140 due to the temperature difference. At this time, the exhaust control unit 230 of the control unit 200 can control the exhaust unit 1800 to operate, and since the exhaust fan 1810 is disposed at a position higher than the second set height, the hot air moved to the upper part can be discharged to the outside through the exhaust unit 1800, and due to this, there is an effect that the cold air being supplied to the lower part of the inner space 1140 moves to the upper part of the inner space 1140, making the air inside the inner space 1140 cooler than the outside, and at the same time, air circulation and ventilation are performed.

In the fourth integrated control condition, the control unit 200 can control the blower unit 1500 to operate and the air conditioning unit and exhaust unit 1800 not to operate. That is, in the fourth integrated control condition, the same operation as in the second integrated control condition can be performed. In detail, in the fourth integrated control condition, the air conditioning control unit 220 of the control unit 200 controls the air conditioning unit not to operate, and at the same time, the blower control unit 210 rotates the third blower fan 1540 in the forward direction to supply the outside air introduced into the blower space 1510 through the air conditioning space 1410 to the inner space 1140, and at the same time, the blower control unit 210 of the control unit 200 rotates the fourth blower fan 1540 in the reverse direction to recover the internal air of the inner space 1140 back to the blower space 1510. In this process, if the third blower fan 1540 and the fourth blower fan 1540 are disposed in the same number, the rotation speed of the third blower fan 1540 is increased, or the number of third blower fans 1540 is increased, or in the case where the number of the third blower fan 1540 is greater than the number of the fourth blower fan 1540, the rotation speed can be kept the same so that the amount of air flowing into the inner space 1140 is greater than the amount of air returning to the blower space 1510, thereby maintaining the pressure of the inner space 1140.

In the fourth integrated control condition, since the air in the inner space 1140 is maintained at a certain level, a problem may occur in which separate circulation does not occur, so to solve this problem, the third blower fan 1540 supplies air in the blower space 1510 to the inner space 1140, while the fourth blower fan 1540 recovers air in the inner space 1140 to the blower space 1510, and since the outside air flowing in from the blower space 1510 and the recovered air are mixed and re-supplied to the inner space 1140 through the third blower fan 1540, the air in the inner space 1140 can be automatically circulated and ventilated.

According to an air dome device according to an embodiment of the present invention, there are effects as follows.

First, the entrance unit 1200 is disposed in front of the membrane unit 1100, and the air conditioning unit and blower unit 1500 are disposed in the rear of the membrane unit 1100, and the underground pipe 1310 is disposed between them, so that the incoming outside air can be primarily heat-exchanged in the ground through the underground pipe 1310 and then flow into the air conditioning space 1410, thereby increasing the heat exchange efficiency of the air conditioning unit and reducing the energy consumption.

In addition, since the blower unit 1500 is designed to include a first blower fan 1520 and a second blower fan 1530 for supplying and recovering air to the flow path blocker 1130, and a third blower fan 1540 and a fourth blower fan 1540 for supplying and recovering air to the inner space 1140, the temperature of the air flowing into the flow path blocker 1130 and the inner space 1140 can be efficiently controlled as needed.

In particular, since the control unit 200 controls the air conditioning unit, blower unit 1500, and exhaust unit 1800 differently in four integrated control conditions, it has the effect of maintaining the temperature of the inner space 1140 of the air dome device uniformly not only in spring or fall but also in summer when the outside temperature is extremely high or in winter when the outside temperature is extremely low.

In addition, during the design process, the position at which air is introduced from the blower space 1510 of the air dome device into the inner space 1140 is set to be below the first set height, and the position at which the air of the inner space 1140 is distributed to the outside is set to be above the second set height. Therefore, the conditioned air supplied to the entire inner space 1140 can be spread throughout the entire inner space 1140, and conversely, the air discharged to the outside for ventilation is efficiently exhausted.

So far, the present invention has been examined with a focus on preferred embodiments. A person having ordinary skill in the art to which the present invention belongs will understand that the present invention can be implemented in a modified form without departing from the essential characteristics of the present invention. Therefore, the disclosed embodiments should be considered from an illustrative rather than a restrictive perspective. The scope of the present invention is indicated in the claims, not in the foregoing description, and all differences within the equivalent scope should be interpreted as being included in the present invention.

What is claimed is:

1. An air dome device comprising:
a membrane unit being formed of a membrane and being extended in one direction to form an inner space in which a set pressure is maintained;
an entrance unit being disposed in front of the membrane unit to allow outside air to flow in and be filtered;
an air conditioning unit being disposed in the rear of the membrane unit to form an air-conditioned space and to control the temperature and humidity of the outside air flowed in from the entrance unit;
a branch pipe in the form of a pipe connecting the entrance unit and the air conditioning unit, which is inserted into the ground to provide a path through which the outside air introduced from the entrance unit exchanges heat with ground heat;
a blower unit being formed with a blower space to blow air in the air-conditioned space or the air in the inner space;
a distribution unit being disposed on one side of the blower space to distribute air being blown from the blower member; and
a distribution line supplying the air distributed from the distribution member to the inner space.

2. The air dome device according to claim 1,
wherein the membrane unit includes:
a first membrane material being disposed on the outside to form an outer skin; and
a second membrane material being disposed between the first membrane material and the inner space to form an inner skin,
wherein a flow path blocker is formed between the first membrane material and the second membrane material.

3. The air dome device according to claim 2,
wherein the blower unit includes:
a first blower fan being disposed in the blower space to supply air through forward rotation; and
a second blower fan being disposed in the blower space to suck air through reverse rotation, and
wherein the distribution line includes:
a first distribution line connecting an inlet side of the distribution unit and the flow path blocker; and
a second distribution line connecting an outlet side of the distribution unit and the flow path blocker.

4. The air dome device according to claim 3,
wherein the first blower fan and the second blower fan operate simultaneously so that conditioned air is introduced from the inlet side of the flow path blocker and conditioned air is discharged from the outlet side of the flow path blocker to the conditioned space, so that the pressure of the flow path blocker is maintained.

5. The air dome device according to claim 1,
wherein the blower unit includes:
a third blower fan for supplying air through forward rotation; and a fourth blower fan for supplying or sucking air through forward or reverse rotation, and
wherein the distribution line includes:
a third distribution line disposed at at least one of one end and the other end of the membrane structure unit so as to be extended from the distribution unit by a set length, and
a fourth distribution line connected to the inner space from the distribution unit, and
wherein the third distribution line is disposed below a first set height.

6. The air dome device according to claim 5,
wherein the third distribution line is provided with a plurality of air inlets disposed at set at a set interval in the extension direction, and
wherein the air inlets is formed to be inclined at a set angle toward the upper center of the membrane structure unit.

7. The air dome device according to claim 5, further including:
an exhaust unit disposed at the rear of the membrane structure unit,
wherein an exhaust fan of the exhaust unit is disposed at a position higher than a second set height for exhausting air in the inner space to the outside, and
wherein the second set height is greater than the first set height.

8. The air dome device according to claim 1, further including:
a housing forming the air conditioning space and the blower space,
wherein the distribution unit is disposed in the housing, and includes:
a first distribution port and a second distribution port for supplying or recovering air blown from the blower unit to the flow path blocker;
at least one third distribution port for supplying air blown from the blower unit to the inner space; and
a fourth distribution port for supplying air blown from the blower unit to the inner space or supplying air in the inner space to the air conditioning space.

9. The air dome device according to claim 1,
wherein the branch pipe is buried in the ground parallel to each other so that a plurality of underground pipes have a length corresponding to the extension length of the membrane unit, and
wherein the inlet of the branch pipe is disposed in the entrance unit and the outlet of the branch pipe is disposed in the air conditioning space of the air conditioning unit.
